(19) United States
(12) Patent Application Publication
(10) Pub. No.: US 2008/0211955 A1
(43) Pub. Date: Sep. 4, 2008

(54) Camera Modules With Lens Drive Device

(76) Inventors: Alon Avital, Haifa (IL); Hovav Elhayani, Yokneam (IL); Gal Peled, Kibbutz Ein Hachoresh (IL); Nir Karasikov, Haifa (IL); Ze'ev Ganor, Herzelia (IL)

Correspondence Address: EMPK & Shiloh, LLP, 116 JOHN ST,, SUITE 1201, NEW YORK, NY, 10038, US

(21) Appl. No.: 11/664,021

(22) PCT Filed: Sep. 27, 2005
(86) PCT No.: PCT/IL05/01037

§ 371 Date: Feb. 19, 2008

(30) Foreign Application Priority Data
Sep. 29, 2004 (JP) 2004-283060U
Sep. 29, 2004 (JP) 2004-283061U
Sep. 29, 2004 (JP) 2004-283193U

(51) Int. Cl. H04N 5/225; G02B 7/02

(52) U.S. Cl. 348/335; 359/824; 348/E05.024

(57) ABSTRACT

A camera module has a plurality of lenses aligned along an optic axis that receive and transmit light from a scene being imaged by the camera module. At least one lens is mounted on a platform which is movable along the optic axis and is moved by action of a piezoelectric motor. Optionally, at least one lens is mounted on a second platform which is movable along the optic axis. The second platform may be driven by a second piezoelectric motor or moved by action of the first platform.

### RELATED APPLICATIONS

This application claims the benefit under 35 U.S.C. 119(a) of Japanese Patent Application No. P2004-283060 filed on Sep. 29, 2004, Japanese Patent Application No. P2004-283061 filed on Sep. 29, 2004, and Japanese Patent Application No. P2004-283193 filed on Sep. 29, 2004 the disclosures of which are incorporated herein by reference.

### FIELD OF THE INVENTION

The invention relates to cameras and in particular camera modules suitable for integration into portable communication devices, such as cell phones, and the portable communication devices comprising such camera modules.

### BACKGROUND OF THE INVENTION

Camera modules embedded in cell phones offer many of the same features offered by conventional digital cameras and comprise many of the same components as conventional digital cameras. Cell phone camera modules generally provide an auto focus (AF) function and a zoom function and comprise a photosensitive surface such as a CCD or CMOS photosurface on which scenes are imaged by the camera module recorded that often has a pixel count that approaches that available with conventional cameras. To provide the AF and zoom functions a cell phone camera module generally comprises a first lens or lens systems, hereinafter collectively referred to as an “auto focus” lens (AF, lens), that functions to focus images on the module photosurface and a second lens or lens system, hereinafter referred to collectively as a “zoom lens”, that provides a zoom function. The AF lens and the zoom lens are mounted respectively to first and second platforms, referred to for convenience as AF and zoom platforms respectively, of a lens transport system so that the optic axes of the AF and zoom lenses are coincident along a common “camera module” optic axis. A suitable motor or actuator comprised in the transport system moves the AF and zoom platforms to position the AF and zoom lenses and provide thereby focusing and zoom functions, i.e. positioning the lenses in various telephoto and wide-angle configurations to image a scene.

Unlike conventional digital cameras, camera modules suitable for embedding in cellular phones must generally be configured to fit into a relatively small space available for a camera function in such phones. Furthermore, whereas there is demand that cell phone camera modules provide image quality and functions that keep pace with improving image quality and an increasing number of functions offered by conventional digital cameras, space available for camera modules in cell phones is generally decreasing as cell phones become thinner and smaller.

### SUMMARY OF THE INVENTION

An aspect of some embodiments of the invention relates to providing a camera module comprising an improved transport system having AF and zoom platforms for moving and positioning AF and zoom lenses comprised in the camera module.

According to an aspect of some embodiments of the invention, the transport system is configured sufficiently small so that the camera module may be embedded in a portable communication device, such as a cellular phone.

According to an aspect of some embodiments of the invention, the transport system comprises at least one rod, hereinafter a “worm-drive shaft”, formed with threads that mesh with corresponding threads formed on an AF and/or a zoom platform of the transport system. The at least one worm-drive shaft is parallel to the optic axis of the camera module and rotation of the shaft translates the AF and/or zoom platform and lenses mounted thereto along the optic axis of the camera module.

Optionally, the at least one worm-drive shaft comprises at least two worm-drive shafts. The AF platform of the worm-drive system is provided with threads that mesh with a worm-drive shaft of the at least two worm-drive shafts and the zoom platform is provided with threads that mesh with a different worm-drive shaft of the at least two worm-drive shafts.

In an embodiment of the invention, each of the AF and zoom platforms is mounted to at least one guide rail, also parallel to the camera module optic axis, along which the platform is able to freely slide. The at least one guide rail contributes to stabilizing orientation of the platform and providing it with accurately controlled motion and positioning. An optionally piezoelectric motor is coupled to each of the at least one worm-drive shaft and is controllable to rotate the shaft to selectively position the AF or zoom platform to which it is coupled, and thereby its associated lens or lens system, along the camera module optic axis to provide telephoto or wide-angle imaging and focusing of a scene.

For convenience of presentation, a transport system in accordance with an embodiment of the invention comprising a worm-drive shaft is referred to as a “worm-drive” system.

According to an aspect of some embodiments of the invention, the transport system, comprises a tube, hereafter a “drive-tube”, that has threads formed on a region of its inside surface and is rotatable about its axis, which axis coincides with the optic axis of the camera module. At least one piezoelectric motor is coupled to the drive-tube and is controllable to rotate the drive-tube. For convenience of presentation, a transport system in accordance with an embodiment of the invention comprising a drive-tube is referred to as a “turret drive” system.

The AF platform of the turret-drive system is formed with threads that match those of the drive-tube and is coupled to the drive-tube by inserting the platform into the drive-tube so that the threads of the platform mesh with those of the drive-tube. At least one linear guide rail along which the AF platform is able to freely slide prevents the platform from rotating when the drive-tube is rotated. As a result, when the at least one piezoelectric motor rotates, the drive-tube, the AF carrier platform translates along the optic axis of camera module. The piezoelectric motor controls the position of the AF platform along the camera module optic axis and thereby of the AF lens mounted to the platform by controlling an angle through which the motor rotates the drive-tube.

The zoom platform of the turret-drive system is also mounted inside the drive-tube. Optionally, the zoom platform does not comprise threads that mesh with those of the drive-tube. Motion of the zoom platform and thereby of the zoom lens along the camera module optic axis is optionally controlled by the AF platform, which can be selectively coupled or uncoupled to the zoom platform so that motion of the AF lens respectively moves or does not move the zoom platform. Optionally, the zoom platform is selectively “dockable” in a telephoto position along the optic axis of the camera module or a wide-angle position along the axis to provide a telephoto or wide-angle image of a scene. Docking of the zoom lens is optionally accomplished by at least one flexible latch and a corresponding at least one catch. The zoom platform is docked in a wide-angle or telephoto position when the at least one flexible latch locks into a corresponding appropriate catch. In either of the positions of the zoom lens, the AF platform is positionable along the camera module optic axis by rotation of the drive-tube to provide appropriate focusing of the image of the scene on the module photosurface.

An aspect of some embodiments of the invention relates to providing a camera module comprising a transmission system having at least one linear rail, hereinafter referred to as a “drive rail”, parallel to the optic axis of the camera module to which the AF and/or zoom platforms are mounted. In accordance with an embodiment of the invention, at least one piezoelectric motor is mounted to the AF platform so that a coupling surface of the motor presses resiliently against a drive rail of the at least one drive rail. The motor is controllable to generate vibrations in its coupling surface that cause the motor, and thereby the AF platform, to “shinny” and translate along the drive rail. For convenience of presentation, a transport system in accordance with an embodiment of the invention in which a platform shinnies along a drive rail, is referred to as a “shinny-drive” system.

Optionally, the at least one drive rail comprises a plurality of drive rails and the at least one motor comprises a plurality of motors. Optionally each motor is resiliently pressed toward a different one of the plurality of drive rails so that the motor's coupling surface presses against the drive rail. Optionally, the transmission system comprises at least one guide rail along which the carrier platform is configured to freely slide or roll. The guide rail contributes to stabilizing orientation of the platform and providing it with accurately controlled motion and positioning. Optionally, the at least one motor is mounted to the platform and pressed towards a drive rail so that it generates a torque that contributes to registering and aligning the platform to the at least one drive rail and/or guide rail.

In an embodiment of the invention, at least one piezoelectric motor is similarly mounted to the zoom platform so that a coupling surface of the motor presses resiliently against a drive rail of the at least one drive rail. The motor is controllable to shinny and translate the zoom platform and thereby its zoom lens along the drive rail.

The piezoelectric motors mounted to the AF and zoom platforms are controllable to translate the AF and zoom platforms along the camera module optic axis to selectively position the AF and/or zoom platforms, and thereby their associated lenses, in telephoto or wide-angle positions along the optic axis.

In an embodiment of the invention, only the AF platform of a shinny-drive system is provided with at least one piezoelectric motor that moves the AF platform and its AF lens along the camera module optic axis. The zoom platform is, optionally, moved and positioned by motion of the AF platform, which can be selectively coupled or uncoupled to the zoom platform so that motion of the AF platform respectively moves or does not move the zoom platform.

Optionally, the zoom platform is selectively “dockable” in a telephoto position along the optic axis of the camera module or a wide-angle position along the axis to provide a telephoto or wide-angle image of a scene. As in the case of a turret-drive system noted above, docking of the zoom lens is optionally accomplished by at least one flexible latch and a corresponding at least one catch. In either the wide-angle or telephoto positions of the zoom platform, the AF platform may be positioned along the camera module optic axis by operation of its at least one piezoelectric motor to provide appropriate focusing of the image on the module photosurface.

Various piezoelectric motors are controllable to provide accurately controlled amounts of kinetic energy to mechanical systems and are suitable for use in transport systems comprised in camera modules in accordance with embodiments of the invention. For example, U.S. Pat. No. 5,616,980 to Zumeris et al, and PCT Publication WO 00/74153 entitled “Multilayer Piezoelectric Motor” describe piezoelectric motors that are suitable for practice of the present invention.

Piezoelectric motors described in the referenced patent and PCT Publication comprise a relatively thin rectangular piezoelectric vibrator having large parallel face surfaces and narrow short and long edge surfaces. Optionally, a surface region of a short edge of the vibrator or a surface of a “friction nub” on a short edge of the vibrator functions as a motor coupling surface that is pressed to a contact surface of a moveable body. Electrodes on the face surfaces of the vibrator or, for piezoelectric motors described in WO 00/74153, on face surfaces of layers of the vibrator, are electrified to excite vibrations in the motor's friction nub that transmit kinetic energy to the moveable body via the body's contact surface. PCT Publication PCT/IL00/00698 entitled “Piezoelectric Motors and Motor Driving Configurations” describes various piezoelectric motors and methods of coupling such motors to rotate moveable bodies. PCT Application PCT/IL03/00613 entitled “High Resolution Piezoelectric Motor” describes piezoelectric motors and methods of operating piezoelectric motors to position an object with relatively high accuracy. The disclosures of all the above referenced documents are incorporated herein by reference.

There is therefore provided in accordance with an embodiment of the invention a camera module having an optic axis and comprising: at least one platform formed with threads and comprising at least one lens that receives and transmits light that reaches the camera module from a scene being imaged by the module; a different drive shaft having an axis parallel to the optic axis for each platform of the at least one platform, which shaft is formed with threads that mesh with the threads in the platform; a contact surface coupled to each drive shaft so that when the contact surface rotates, the drive shaft rotates; and a piezoelectric motor controllable to rotate the contact surface and thereby the shaft to move and position the platform whose threads mesh with those of the shaft along the optic axis.

Optionally the camera module has at least one linear guide parallel to the optic axis along which the at least one platform moves substantially freely that prevents the platform from rotating relative to the drive shaft whose threads mesh with those of the platform.

Additionally or alternatively, the contact surface is optionally, a surface of a drive wheel coupled to the drive shaft, which drive wheel has an axis of rotation parallel to the axis of rotation of the drive shaft.

In an embodiment of the invention, the piezoelectric motor that rotates the contact surface comprises a coupling surface that is pressed to the contact surface and wherein motion of the coupling surface rotates the contact surface and thereby the drive shaft.

In an embodiment of the invention, the piezoelectric motor comprises a rectangular piezoelectric vibrator having large parallel face surfaces and short and long edge surfaces. Optionally, the coupling surface of the motor is located on an edge surface of the vibrator. Optionally, the edge surface is a short edge surface.

In an embodiment of the invention, the camera module comprises a motor mount that holds the piezoelectric motor with its long edge surfaces substantially parallel to the optic axis.

In an embodiment of the invention, the camera module comprises a resilient element that urges the piezoelectric motor so that it's coupling surface presses against the contact surface.

Additionally or alternatively, the camera module optionally comprises a camera module housing to which the motor mount is mounted. Optionally, the camera module housing has a substantially cubic shape. Additionally or alternatively, the camera module housing comprises at least one bearing for each drive shaft to which the drive shaft is mounted. Optionally, a bearing of the at least one bearing to which a drive shaft is mounted is spring loaded.

In an embodiment of the invention, the at least one platform comprises a plurality of platforms. Optionally, the plurality of platforms comprises two platforms.

There is further provided in accordance with an embodiment of the invention, a camera module having an optic axis and comprising: a drive-tube rotatable about the optic axis and having an inside surface formed with a thread and an axis of rotation coincident with the optic axis; a first platform mounted inside the drive-tube having a thread that meshes with the thread of the drive-tube and comprising at least one lens that receives and transmits light that reaches the camera module from a scene being imaged by the module; at least one guide rail along which the first platform slides freely that prevents the platform from rotating when the drive tube is rotated; and at least one piezoelectric motor controllable to rotate the drive tube and thereby to move and position the first platform along the optic axis.

Optionally, the piezoelectric motor comprises a coupling surface that is pressed to a contact surface of the tube and the motor is controlled to generate motion in its coupling surface to rotate the tube. Optionally, the drive-tube comprises an annular collar concentric with the axis of the drive-tube and the contact surface is a surface of the collar.

In an embodiment of the invention, the piezoelectric motor comprises a rectangular piezoelectric vibrator having large parallel face surfaces and short and long edge surfaces. Optionally, the coupling surface of the motor is located on an edge surface of the vibrator. Optionally, the edge surface is a short edge surface.

In an embodiment of the invention, the camera module comprises a motor mount that holds the piezoelectric motor with its long edges substantially parallel to the optic axis. Optionally, the camera module comprises a camera module housing to which the motor mount is mounted.

In an embodiment of the invention, the camera module comprises a resilient element that urges the piezoelectric motor so that its coupling surface presses against the contact surface.

In an embodiment of the invention, the camera module comprises a second platform mounted inside the drive tube and having at least one lens that receives and transmits light that reaches the camera module from the scene. Optionally, the second platform does not have threads that mesh with the threads of the drive-tube. Additionally or alternatively, the second platform optionally slides freely along the at least one guide rail.

In an embodiment of the invention, the second platform is coupled to the first platform so that it can slide along the optic axis between first and second positions relative to the first platform. Optionally, at the first position the first and second platforms substantially touch.

In an embodiment of the invention, the camera module comprises at least one latch and a matching catch operable to secure the second platform at at least one predetermined position along the optic axis. Optionally, the catch comprises a groove formed in the second platform. Optionally, the latch extends along a direction parallel to the optic axis.

There is further provided in accordance with an embodiment of the invention, a camera module having an optic axis and comprising: at least one drive rail parallel to the optic axis; at least one first platform comprising at least one lens that receives and transmits light that reaches the camera module from a scene being imaged by the module and comprises at least one piezoelectric motor having a coupling surface that contacts the at least one drive rail; wherein, the at least one piezoelectric motor is controllable to excite vibrations in the coupling surface that apply force to the drive rail so as to move and position the first platform along the optic axis.

Optionally, the at least one drive rail comprises a plurality of parallel drive rails. Optionally, the at least one piezoelectric motor comprises a different piezoelectric motor for each drive rail which motor has a motor coupling surface that contacts the drive rail.

In an embodiment of the invention, the platform comprises an arm for each piezoelectric motor of the at least one piezoelectric motor that holds the motor and is connected to a main central body of the platform. Optionally, the arm is connected to the main body of the platform by a relatively thin neck that enables the arm td elastically bend away from the main body. Additionally or alternatively, the arm is optionally an integral part of the platform defined by a slot formed in the platform.

In an embodiment of the invention, the camera module comprises a resilient body that presses the coupling surface to contact a drive rail of the at least one drive rail. Optionally, the resilient body operates to urge the arm away from the main body of the platform.

In an embodiment of the invention, the camera module comprises at least one guide rail parallel to the drive rail along which the platform moves substantially freely that prevents the platform from rotating relative to the drive rail. Optionally, forces generated by the resilient body between the coupling surface of each motor and the drive rail to which it is pressed generate torque that urges the platform to the at least one guide rail.

In an embodiment of the invention, the platform comprises at least one bearing having a component that rolls along the at least one guide rail.

Optionally, the rolling component and the guide rail have corresponding complementary surfaces that substantially prevent the guide rail and rolling component from displacing laterally with respect to the guide rail. Optionally, one of the complementary surfaces is a convex surface and the other a concave surface.

In an embodiment of the invention, the rolling component comprises a wheel. Optionally, the wheel is formed with a groove that matches the shape of the complementary surface of the guide rail.

In an embodiment of the invention, the at least one guide rail comprises a plurality of parallel guide rails.

In an embodiment of the invention, the at least one first platform comprises two first platforms.

In an embodiment of the invention, the camera module comprises a second platform having at least one lens that receives and transmits light that reaches the camera module from the scene. Optionally, the second platform is coupled to a first platform of the at least one first platform so that it can slide along the optic axis between first and second positions relative to the first platform. Optionally, at the first position the first and second platforms substantially touch.

In an embodiment of the invention, the camera module comprises at least one latch and a matching catch operable to secure the second platform at at least one predetermined position along the optic axis. Optionally, the catch comprises a groove formed in the second platform. Optionally, the latch extends along a direction parallel to the optic axis.

In an embodiment of the invention, the camera module comprises a collecting lens that receives light that reaches the camera module from the scene and transmits the received light to the at least one lens comprised in the at least one platform.

In an embodiment of the invention, the camera module comprises a photosurface for sensing light from the scene imaged by the camera.

There is further provided, in accordance with an embodiment of the invention, a portable terminal comprising a camera module according to any of the preceding claims. Optionally, the portable terminal comprises a communication module for transmitting and/or receiving signals. Additionally or alternatively, the portable terminal comprises a display screen.

In an embodiment of the invention, the portable terminal comprises a housing in which components of the terminal are housed. Optionally, a dimension of the housing is substantially equal to a dimension of the camera module. Optionally, the dimension of the housing is a thickness of the housing. Additionally or alternatively, the dimension of the camera module is a maximum dimension of the camera module parallel to its optic axis.

In an embodiment of the invention, the portable terminal comprises a cell phone.

In an embodiment of the invention, the portable terminal comprises a bar-code reader.

### BRIEF DESCRIPTION OF FIGURES

Non-limiting examples of embodiments of the present invention are described below with reference to figures attached hereto. In the figures, which are listed following this paragraph, identical structures, elements or parts that appear in more than one figure are generally labeled with a same reference numeral in all the figures in which they appear. Dimensions of components and features shown in the figures are chosen for convenience and clarity of presentation and are not necessarily shown to scale.

FIGS. 1A and 1B schematically show different perspective views of a camera module worm-drive system comprising AF and zoom platforms for positioning AF and zoom lenses in the camera module, in accordance with an embodiment of the present invention;

FIG. 1C schematically shows a partially cutaway perspective view of a camera module comprising the worm-drive system shown in FIGS. 1A and 1D, in accordance with an embodiment of the invention;

FIGS. 1D schematically shows details of a piezoelectric motor comprised in the worm-drive system shown in FIGS. 1A and 1B and details of its operation, in accordance with an embodiment of the invention;

FIGS. 1E and 1F schematically show the camera module worm-drive system shown in FIGS. 1A and 1B with its AF and zoom lenses in a wide-angle and telephoto positions, in accordance with an embodiment of the invention;

FIG. 1G schematically shows a cell-phone comprising the camera module shown in FIGS. 1A-1C, in accordance with an embodiment of the invention;

FIG. 2A schematically shows an exploded view of a camera module comprising a turret-drive system in accordance with an embodiment of the invention;

FIG. 2B schematically shows the camera module shown in FIG. 2A partially assembled, in accordance with an embodiment of the invention;

FIG. 2C schematically shows a cutaway view of the camera module shown in FIG. 2B, in accordance with an embodiment of the invention;

FIGS. 2D and 2E schematically show cutaway views of the camera module shown in FIG. 2B, with the AF and zoom platforms in wide-angle and telephoto positions respectively in accordance with an embodiment of the invention;

FIGS. 3A and 3B schematically show different perspective views of a camera module shinny-drive system comprising AF and zoom platforms for positioning AF and zoom lenses in the camera module, in accordance with an embodiment of the present invention;

FIG. 3C schematically shows a view of the shinny-drive system shown in FIGS. 3A and 3B, partially disassembled to show details of the AF platform in the shinny-drive system, in accordance with an embodiment of the invention;

FIG. 3D schematically shows a plan view of the AF platform shown in FIG. 3C, in accordance with an embodiment of the invention;

FIGS. 3E schematically shows a plan view of a variation of the AF platform shown in FIGS. 3C and 3D, in accordance with an embodiment of the invention;

FIG. 3F schematically shows a variation of the shinny-drive system shown in FIGS. 3A and 3B, in accordance with an embodiment of the invention;

FIG. 3G schematically shows another variation of the shinny-drive system shown in FIGS. 3A and 3B, in accordance with an embodiment of the invention;

FIG. 3H schematically shows a latching mechanism for selectively docking a zoom lens platform in telephoto or wide angle positions in accordance with an embodiment of the invention;

FIGS. 3I and 3J schematically illustrate operation of the docking mechanism shown in FIG. 3H; and

FIG. 4 schematically shows another camera module shinny-drive system, in accordance with an embodiment of the invention.

### DETAILED DESCRIPTION OF EXEMPLARY EMBODIMENTS

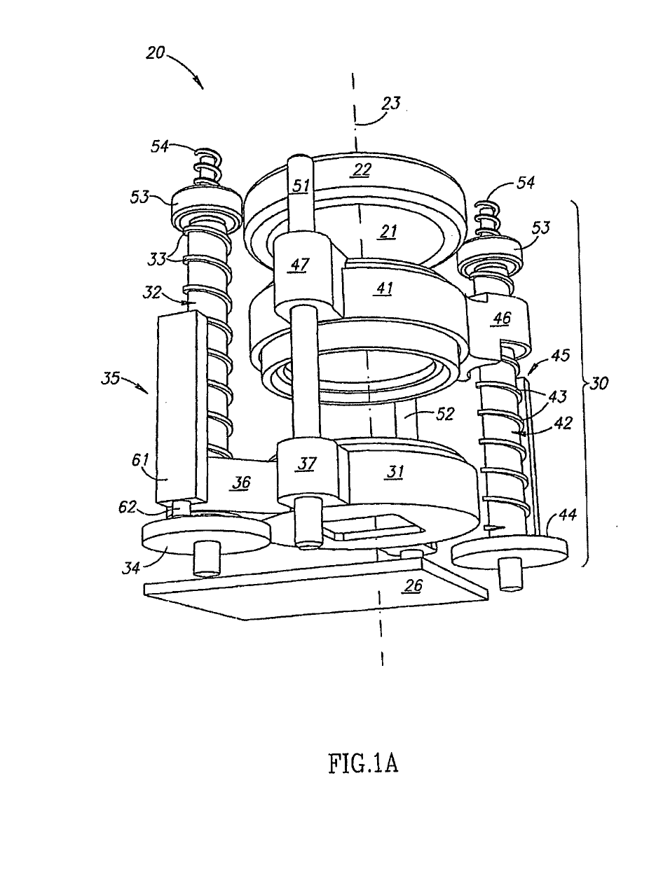

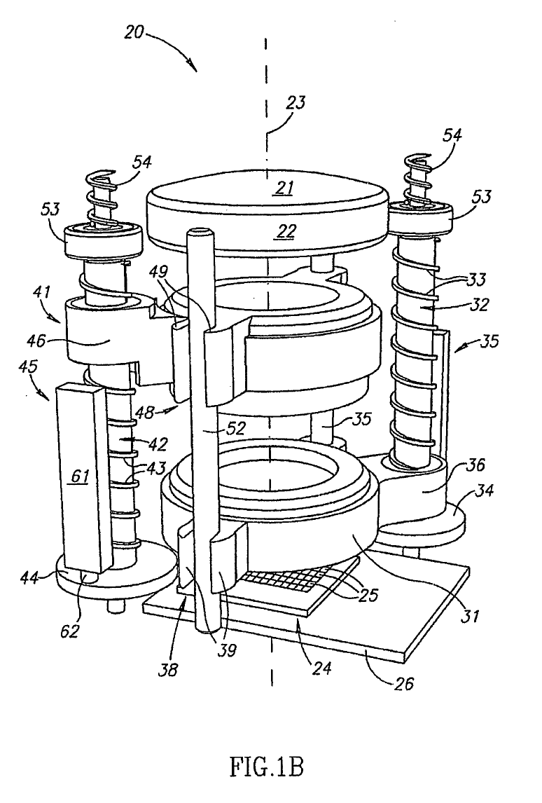

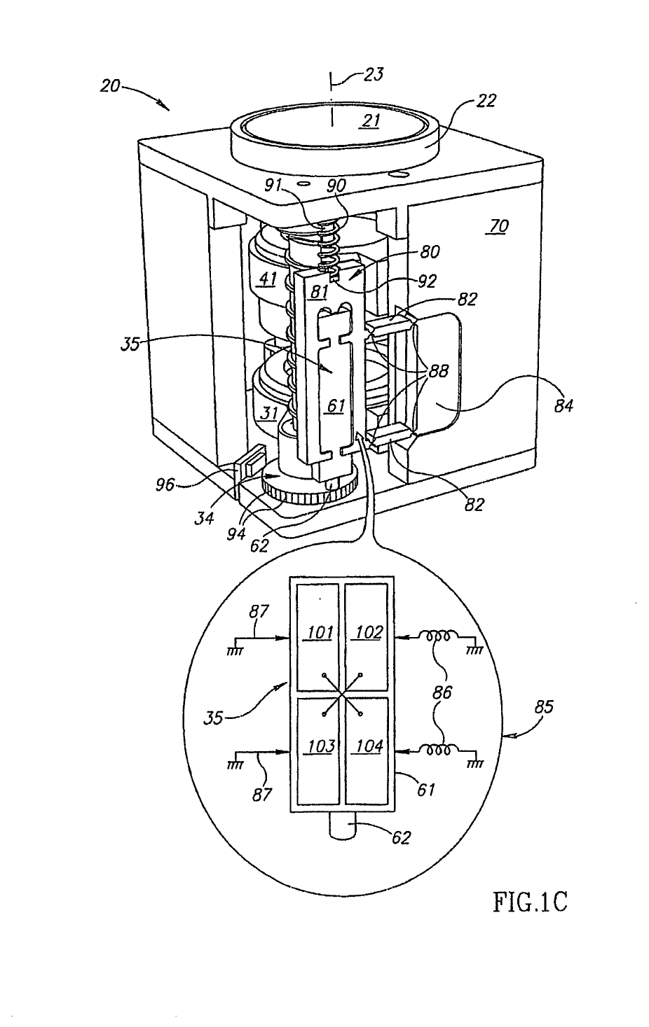

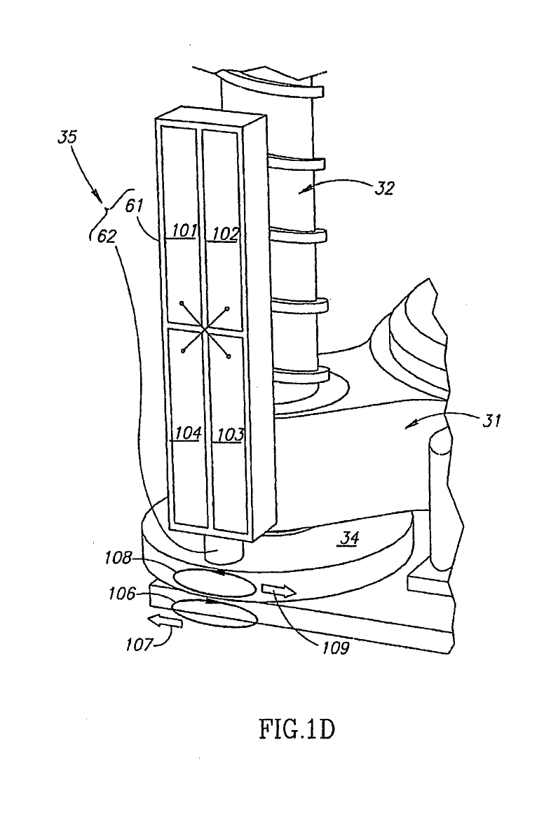

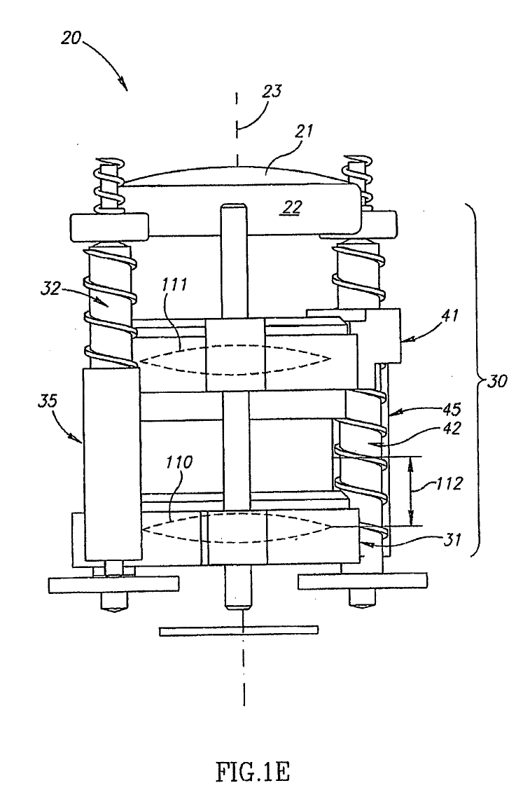

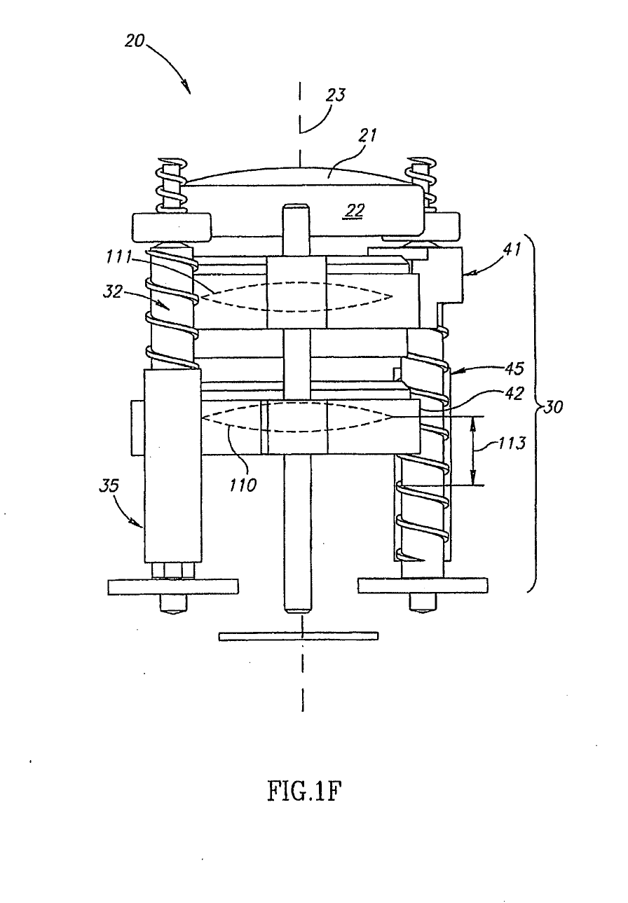

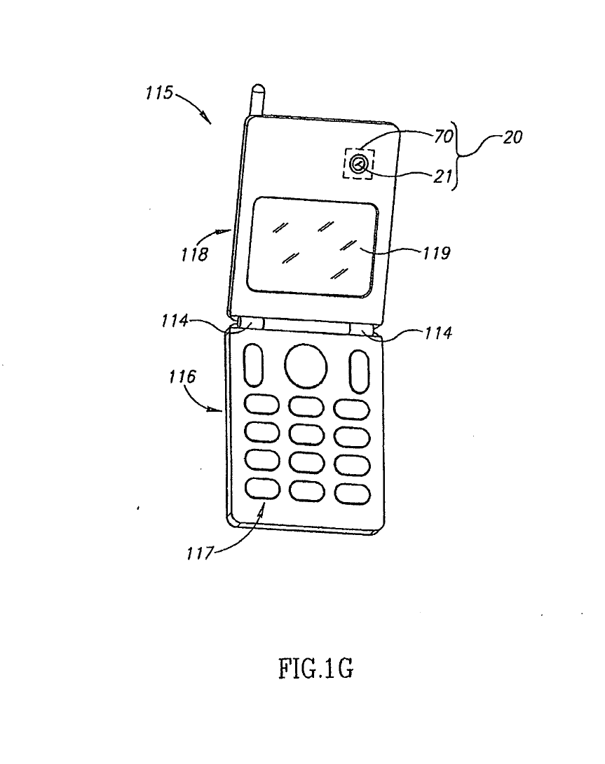

FIGS. 1A and 1B schematically show different perspective views of components of a camera module 20, in accordance with an embodiment of the present invention.

Camera module 20 optionally comprises a worm-drive system 30 comprising AF and zoom platforms 31 and 41 for positioning AF and zoom lenses or lens systems (not shown in FIGS. 1A and 1B) in the camera module that are respectively mounted to the AF and zoom platforms. A collecting lens 21 is optionally mounted to a collecting lens frame 22 and has an optic axis coincident with an optic axis, represented by a dashed line 23, of camera module 20. Collecting lens 21 receives light from a scene being imaged by camera module 20 and transmits the collected light to zoom and AF lenses mounted to AF and zoom platforms 31 and 41. Worm drive system 30 positions the AF and zoom lens platforms 31 and 41 and thereby their respective AF and zoom lenses to selectively focus the received light in a wide-angle or telephoto image of the scene on a CCD or CMOS photosurface 24 (FIG. 1B) having pixels 25. Photosurface 24 is optionally mounted or formed on a “wiring” substrate 26 optionally having a configuration of circuit elements (not shown) for processing signals generated by pixels 25 to provide an image of the scene.

Worm-drive system 30 optionally comprises first and second worm-drive shafts 32 and 42, which are formed with threads 33 and 43 respectively and at least one guide rail, all of which are parallel to the optic axis of camera module 20. Optionally, as shown in FIGS. 1A and 1B, the at least one guide rail comprises two guide rails 51 and 52. Optionally, each worm-drive shaft 32 and 42 is held by a first bearing 53 optionally spring loaded by a resilient element represented by a coil spring 54 and a second bearing (not shown), which are mounted to a housing of the camera. The second bearing is substantially rigidly mounted to the housing. Element 54 resiliently urges first bearing 53 towards the second bearing so that the worm-drive shaft 32 or 42 seats stably in the second bearing preventing or substantially reducing thereby play in the position of the drive shaft relative to the bearings. The worm-drive shaft and thereby its threads 33 or 43 are therefore relatively accurately positioned along the length of optic axis 23. Optionally, worm-drive shafts 32 and 42 are mounted to a housing 70 of camera module 20 as shown in FIG. 1C and discussed below.

Worm-drive shafts 32 and 42 are optionally attached to drive wheels 34 and 44 respectively that are coupled to piezoelectric motors 35 and 45 respectively, which are operable to rotate the drive wheels and thereby drive shafts 32 and 42. Optionally, each piezoelectric motor 35 and 45 comprises a rectangular piezoelectric vibrator 61 having a friction nub 62 mounted or formed on a narrow edge thereof and is similar to a piezoelectric motor described in U.S. Pat. No. 5,616,980 or PCT Publication WO 00/74153 referenced above. Other suitable piezoelectric motors known in the art may be used in the practice of the invention and be substituted for the motors shown in the figures. Each motor 35 and 45 is mounted to a suitable motor mount, which holds the motor and resiliently urges the motor towards its associated drive wheel 34 or 44 so that the motor's friction nub 62 is resiliently pressed to the drive wheel. A motor mount in accordance with an embodiment of the invention is schematically shown in FIG. 1C and described below.

AF platform 31 is formed so that it has threads that mesh with threads 33 of worm-drive shaft 32 and is optionally coupled to at least one of guide rails 51 and 52 so that it slides freely along the at least one guide rail. Rotation of worm-drive shaft 32 therefore causes AF platform 31 to translate along optic axis 23. Worm-drive shaft 32 is selectively controlled to rotate in a clockwise or counterclockwise direction and translate AF platform 31 towards or away from collecting lens 21 by exciting piezoelectric motor 35 to generate appropriate vibrations in friction nub 62 and apply thereby a torque to drive wheel 34. Clockwise and counterclockwise rotation of worm-drive shaft 32 is defined with reference to a suitable direction along the axis of the drive shaft. Hereinafter, the directions towards or away from collecting lens 21 are respectively referred to as up or down. Details of the operation of piezoelectric motor 35 are discussed below with reference to FIG. 1D.

Optionally, to couple AF platform 31 to worm-drive shaft 32, the AF platform comprises a coupling protrusion 36 formed with a threaded hole through which worm-drive shaft 32 passes and whose threads mesh with threads 33 of the worm-drive shaft. Optionally, the AF platform couples to each guide rail 51 and 52. Optionally, to couple with first and second guide rails 51 and 52, AF platform 31 has a first guide protrusion 37 formed with a hole through which first guide rail 51 passes and a bifurcated guide protrusion 38 (FIG. 1B) having two arms 39 that “embrace” second guide rail 52.

Zoom platform 41 is optionally coupled to worm-drive shaft 42 and guide rails 51 and 52 similarly to the manner in which AF platform 31 is coupled to worm-drive shaft 32 and guide rails 51 and 52. Optionally, the zoom platform 41 has a coupling protrusion 46 formed with a threaded hole through which worm-drive shaft 42 passes and whose threads mesh with threads 43 of the worm-drive shaft. Optionally, to couple with first and second guide rails 51 and 52, zoom platform 41 has a first guide protrusion 47 formed with a hole through which first guide rail 51 passes and a bifurcated guide protrusion 48 (FIG. 1B) having two arms 49 that embrace second guide rail 52.

By controlling motor 45 to selectively rotate drive wheel 44 and thereby drive shaft 42 clockwise or counter-clockwise with reference to a suitable direction along the axis of the drive shaft, zoom platform 41 is selectively translated along optic axis 23 up or down.

FIG. 1C schematically shows a partially cutaway view of camera module 20 with collecting lens 21 and worm-drive 30 mounted in a camera module housing 70. Housing 70 is partially cutaway to reveal details of camera module 20 and in particular details of a motor mount for supporting piezoelectric motors 35 and 45 so that the motors properly couple to their respective drive wheels 34 and 44, in accordance with an embodiment of the invention. In the perspective of FIG. 1C piezoelectric motor 35 and its motor mount 80 are shown. Piezoelectric motor 45, which is not shown in the figure, is optionally mounted similarly to the way in which piezoelectric motor 35 is mounted to housing 70. Optionally, camera housing 70 has a substantially cubic shape.

Motor mount 80 optionally comprises a holding frame 81 optionally coupled by two flexible extensor arms 82 that are attached to a base block 84. Base block 84 is secured to housing 70 using any of various methods known in the art, such as by being glued and/or press fit into a recess in housing 70. Extensor arms 82 are formed with relatively thin regions 88 that provide flexibility to the arms in a direction parallel to the length of piezoelectric motor 35 but are sufficiently wide in a direction perpendicular to the plane of the motor so that they are relatively rigid in that direction. A resilient element optionally a coil spring 90, urges holding frame 81 towards drive wheel 34 so that friction nub 62 of piezoelectric motor 35 resiliently presses on the drive wheel. Optionally, flexible element 90 is mounted to a support stub 91 of housing 70 and extends into a recess 92 at the top of holding frame 81.

An inset 85 schematically shows internal details of the manner in which holding frame 80 optionally supports piezoelectric motor 35 and details of an optional configuration of electrodes 101-104 formed on vibrator 61 of the motor that are discussed below with reference to FIG. 1D. Holding frame 81 optionally comprises two resilient elements 86 located inside the frame that press vibrator 61 of piezoelectric motor 35 against optionally two support nubs 87 positioned respectively opposite the resilient elements. Optionally, support nubs 87 and resilient elements 86 contact vibrator 61 at nodes of resonant vibrations of the vibrator that are excited by electrifying electrodes 101-104 to generate vibrations in friction nub 62.

Optionally, camera module 20 is provided with a monitoring system that monitors rotation of each worm-drive shaft 32 and 42 (FIGS. 1A and 1B). Any of various position monitoring sensors and systems known in the art may be used in the rotation monitoring system to monitor rotation angle of the worm drive shafts. Optionally, the monitor system comprises fiducial markings 94 located on the perimeter of each drive wheel 34 and 44 (shown only on drive wheel 34 in FIG. 1C) and a photosensor 96 mounted to housing 70 that senses motion of the markings and generates signals responsive thereto. The signals are optionally transmitted to a suitable controller (not shown) that uses the signals to control piezoelectric motors 35 and 45 to provide desired rotation of drive shafts 32 and 42 and thereby desired positions of AF and zoom platforms 31 and 41.

FIG. 1D schematically illustrates how piezoelectric motor 35 operates to rotate drive wheel 34 and thereby worm-drive shaft 32 to translate AF platform 31.

Piezoelectric motor 35 optionally comprises four quadrant electrodes 101-104 formed on a first large face surface of piezoelectric vibrator 61 and a single large electrode (not shown) on a second large face surface of the vibrator. Diagonal electrodes are optionally electrically connected.

In an embodiment of the invention, to control motor 35 to rotate drive wheel 34 and worm-drive shaft 32 clockwise, diagonal electrodes 101 and 103 are electrified relative to the large electrode with a first AC voltage, optionally at a resonant frequency of the vibrator. Diagonal electrodes 102 and 104 are optionally electrified with a second AC voltage, 180° out of phase with the first voltage. Electrification of the electrodes causes vibrator 61 to vibrate in the plane of the vibrator with longitudinal vibrations parallel to the vibrator's long dimension and transverse “bending vibrations” parallel to the short dimension of the vibrator. The vibrations generate clockwise (as seen from the point of view of the reader) elliptical vibrations in friction nub 62 having an “orbit” schematically represented by a “clockwise” ellipse 106. For a portion of every cycle of elliptical vibration 106 along the bottom of ellipse 106, friction nub 62 contacts drive wheel 34 and applies a force indicated by a block arrow 107 that turns the drive wheel clockwise (as seen from the top of drive shaft 32). For the rest of elliptical cycle 106 the friction nub does not contact the drive wheel. By reversing the polarities of the AC voltages applied to diagonal electrode pairs 101-103 and 102-104, the elliptical vibrations are reversed and become counterclockwise vibrations schematically represented by a counterclockwise ellipse 108. The counterclockwise vibrations apply a force represented by a block arrow 109 that is in a direction opposite that of block arrow 107 to drive wheel 34 that rotates the drive wheel in a counterclockwise direction.

Other electrification configurations known in the art may be used in accordance with an embodiment of the invention to operate piezoelectric motor 35 and rotate worm-drive shaft 32. For example, piezoelectric motor 35 may be operated in an asymmetric pulsed mode to rotate drive shaft 32. In this mode, electrodes on piezoelectric vibrator 61 are electrified with asymmetric pulses that cause the piezoelectric vibrator to bend in its plane to displace friction nub to one side relatively rapidly or relatively slowly and then displace the friction nub back in the opposite direction respectively relatively slowly or relatively rapidly. During the relative rapid displacement, friction between friction nub 62 and drive wheel 34 is relatively large and the drive wheel moves with the friction nub and rotates. During the relatively rapid motion of friction nub 62, friction between the nub and the drive wheel is relatively low, the friction nub slides over the surface of drive wheel 34 to which it is pressed and the drive wheel substantially does not move with the friction nub and substantially does not rotate. For each cycle of a rapid and slow motion of friction nub 62, drive wheel 34 undergoes a net rotation in a direction determined by the slow displacement of the friction nub.

By way of example, to operate in the asymmetric pulsed mode, electrodes 101 and 104 are optionally electrically connected and pulsed with a same unipolar asymmetric pulse having a relatively short rise time and relatively long fall time. Electrodes 102 and 104 are optionally electrically connected and electrified with a pulse that is the negative of the pulse that electrifies electrodes 101 and 104. The asymmetric pulses applied to the electrodes cause vibrator 61 to bend and displace friction nub 62 to the right (assuming appropriate correspondence between the polarity of the pulse and polarization of piezoelectric vibrator 61) relatively rapidly during the pulses rise time. During the relatively long fall time, piezoelectric vibrator 61 slowly relaxes and unbends, returning friction nub 62 relatively slowly to its original position.

Methods of exciting piezoelectric motors similar to piezoelectric motors 35 and 45 are described in U.S. Pat. No. 5,616,980, PCT Publication WO 00/74153, and PCT Applications PCT/IL00/00698 and PCT/IL03/00613 referenced above and may be used in the practice of the invention. U.S. Pat. No. 5,616,980, describes a number of different electrification configurations for electrifying electrodes of a piezoelectric motor similar to piezoelectric motors 35 and 45 to operate the motor in an asymmetric pulsed mode.

FIGS. 1E and 1F schematically show side views of worm-drive system 30 comprised in camera module 20 in which piezoelectric motors 35 and 45 have been controlled to position AF and zoom platforms 31 and 41 so that their respective AF and zoom lenses are configured in wide-angle and telephoto configurations respectively. In the figures, AF and zoom lenses comprised in AF and zoom platforms 31 and 41 are schematically represented by dashed line single lens cross-sections 110 and 111.

In the wide-angle configuration shown in FIG. 1E, AF and zoom lenses 110 and 111 are located relatively far from collecting lens 21. A double arrow-head line 112 schematically indicates, for the position of zoom lens 111 shown in FIG. 1E, a range of positions for AF lens 110 over which piezoelectric motor 35 moves the AF lens to focus a scene imaged by camera module 20. In the telephoto configuration shown in FIG. 1F, AF and zoom lenses 110 and 111 are located relatively close to collecting lens 21. A double arrow-head line 113 schematically indicates, for the position of zoom lens 111 shown in FIG. 1F, a range of positions for AF lens 110 over which piezoelectric motor 35 moves the AF lens to focus a scene imaged by camera module 20.

FIG. 1G schematically shows a plan view of a portable terminal comprising a communication module for transmitting and/or receiving signals. Optionally, the portable terminal comprises a cell phone 115 comprising a camera module such as camera module 20, in accordance with an embodiment of the invention. Cell phone 115 optionally comprises a first panel 116 having a user interface comprising a keyboard 117 and a second panel 118 comprising a display screen 119. Panel 118 is hinged by hinges 114 to first panel 116 so that it can be opened from and closed to the first panel and the panels are electrically coupled using any of various methods and devices known in the art to enable communication of signals between them. Camera module 20 is, optionally, mounted in panel 118 and its camera housing 70 (FIG. 1C) is schematically indicated by a dashed line. Collecting lens 21 of camera module 20 is visible through an aperture in second panel 118 through which the collecting lens collects light from a scene being imaged by camera module 20. Camera module 20 is controlled to image a scene responsive to operation of an optionally dedicated button on one of panels 116 or 118 and/or a dedicated button and/or keys on keyboard 117. An imaged scene is optionally displayed on display screen 119.

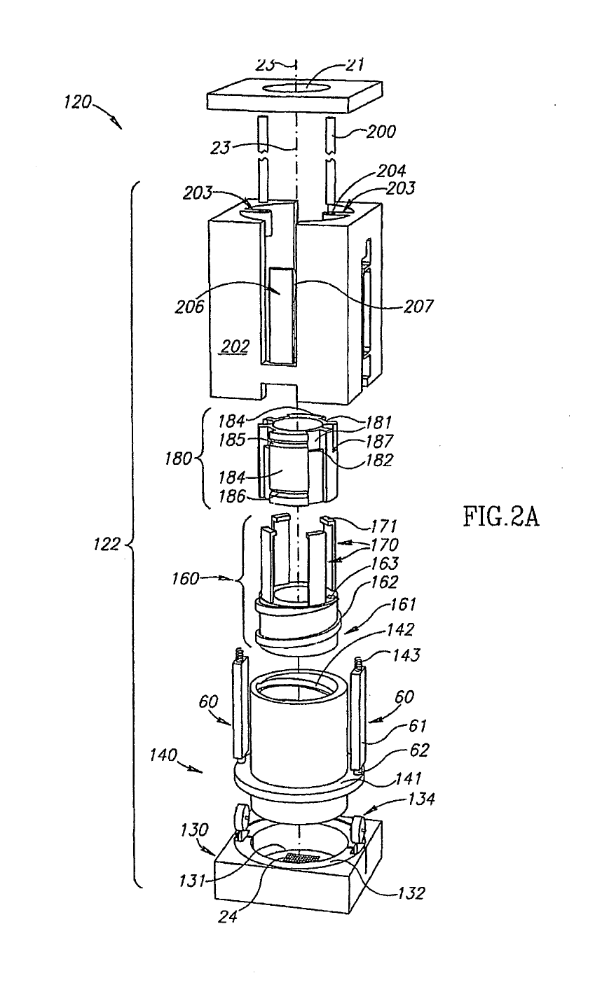

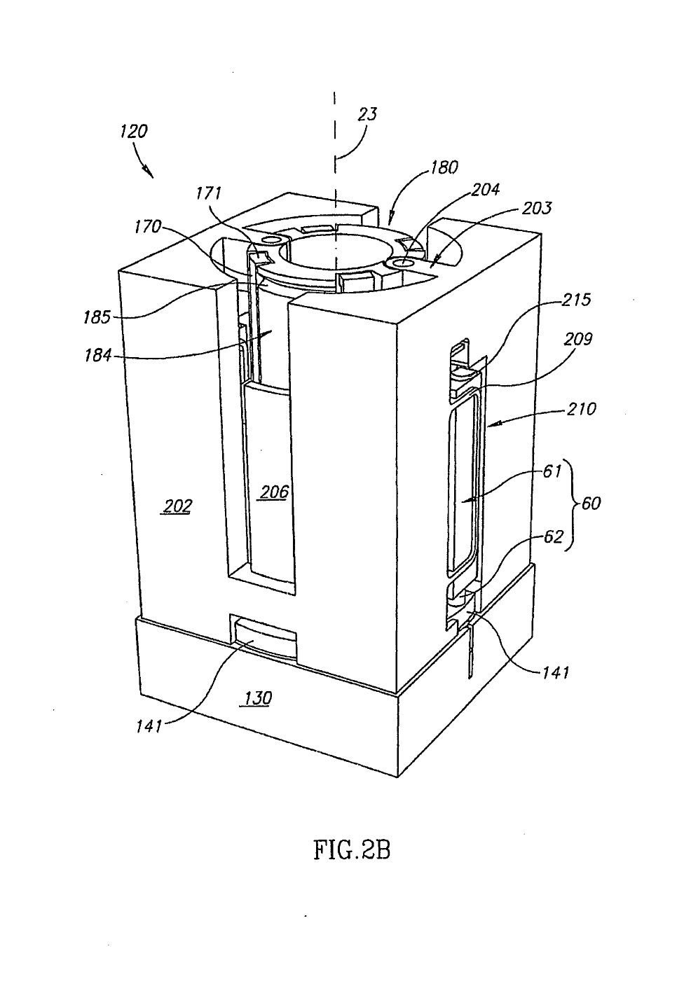

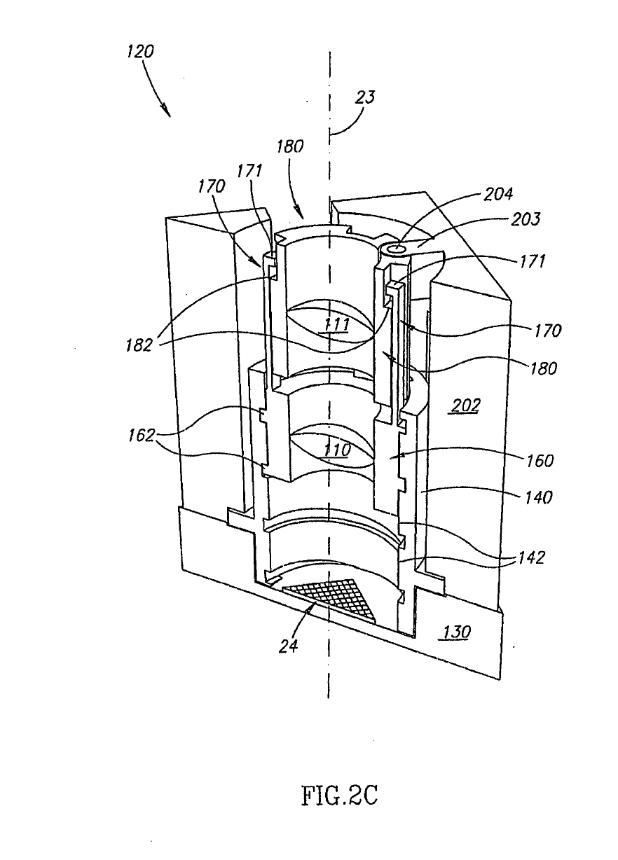

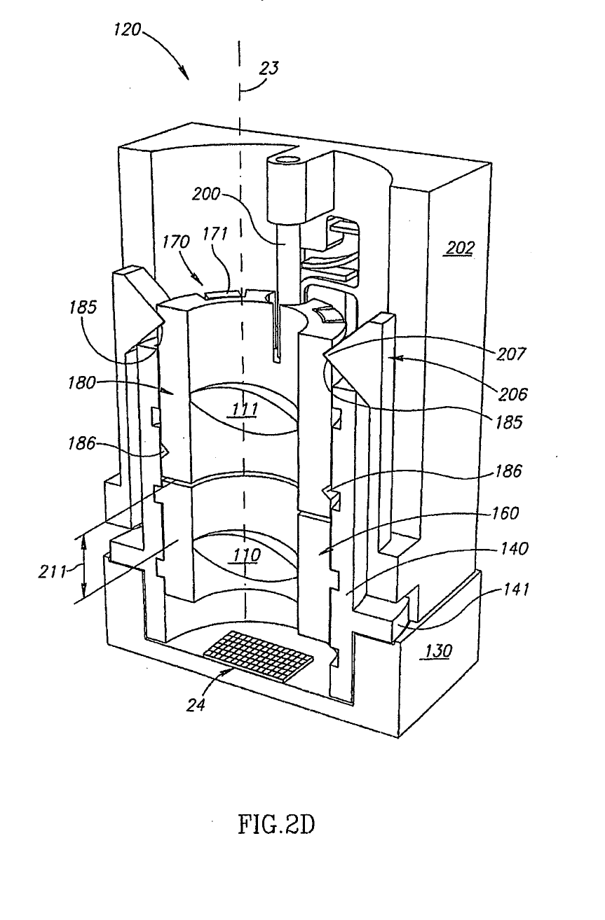

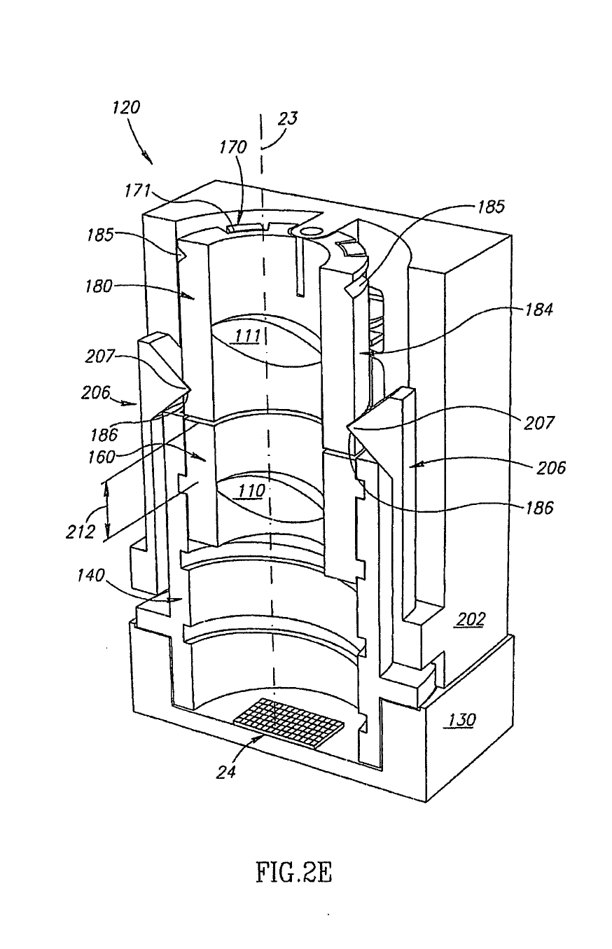

FIG. 2A schematically shows an exploded view of a camera module 120 comprising a turret-drive system 122, in accordance with an embodiment of the invention. FIG. 2B schematically shows camera module 120 partially assembled. For convenience of presentation, collecting lens 21, shown in FIG. 2A mounted to housing 202, has been omitted in FIG. 2B.

Turret-drive system 122 optionally comprises a base 130, a drive-tube 140, an AF platform 160 and a zoom platform 180 to which AF and zoom lenses respectively of camera module 120 are mounted and guide rails 200. Camera module 120 also comprises a housing 202, parts of which function as components of the turret-drive system and a collecting lens 21 having an optic axis coincident with an optic axis 23 of camera module 120.

Base 130 is optionally formed with a circular well 131, an annular recess 132 concentric with the well and optionally, bearings of any suitable configuration known in the art represented by two wheels 134, which are optionally mounted in or relative to the base so that they protrude into or rest on the surface of the annular recess. A photosensitive surface 24, such as a CCD or CMOS is optionally located at the bottom of well 131 on a suitable substrate, which optionally comprises a wiring substrate for the photosurface.

Drive-tube 140 optionally comprises a drive collar 141 and has threads 142 formed on its inside surface. The drive-tube is configured so that it may be seated in well 131 with drive collar 141 contacting and riding on wheels 134. At least one piezoelectric motor 60, optionally similar to piezoelectric motors 35 and 45 and comprising a piezoelectric vibrator 61 and friction nub 62 is coupled to drive collar 141 and is controllable to apply force to the drive collar to selectively rotate the drive collar clockwise or counterclockwise around camera module optic axis 23.

To couple each of the at least one piezoelectric motor 60 to drive collar 141, a resilient element, represented by a coil spring 143, urges the motor toward the collar so that the motor's friction nub presses on the drive collar. Whereas resilient element 143 is represented by a coil spring, the resilient element may be any suitable resilient element known in the art such as a leaf spring or a suitably shaped mass of a resilient material, such as a rubber. By way of example, in FIG. 2A, the at least one piezoelectric motor 60 comprises two piezoelectric motors. Each motor 60 is optionally pressed to contact drive collar 141 at a location of the drive collar opposite that at which a different wheel 134 contacts the collar.

AF platform 160 comprises an optionally tubular section 161 formed with threads 162 on its outer surface, which match threads 142 formed in drive-tube 140, and guide rail holes 163, only one of which can be seen in the perspective of FIG. 2A, for receiving guide rails 200. AF platform 160 also has a plurality of coupling arms 170 for coupling the AF platform to zoom lens platform 180, each of which extends “upwards” towards the zoom platform and ends in a short “tooth” 171 that faces optic axis 23.

For each coupling arm 170, zoom platform 180 optionally comprises a region 181 on its external surface that is formed with a step 182, which matches tooth 171 of the coupling arm. Zoom platform 180 may be inserted between coupling arms 170 so that teeth 171 of coupling arms 170 are snapped over steps 182 and couple the zoom platform to the AF platform, yet allow the zoom platform to slide along the coupling arms. Zoom platform 180 is able to slide relative to AF platform 160 optionally from a position at which both platforms touch, to a position at which they are separated by a maximum distance, at which distance teeth 171 catch on steps 182 and prevent further separation of the platforms.

FIG. 2C shows a schematic cutaway view of camera module 120 partially assembled in which two of coupling arms 170 are shown in relation to steps 182 for zoom platform 180 displaced along optic axis 23 from AF platform 160 by a distance for which teeth 171 do not catch on steps 182. Also schematically shown in FIG. 2C are AF lens 110 and zoom lens 111 mounted respectively in AF and zoom platforms 160 and 180.

As shown in FIG. 2A, zoom platform 180 also comprises at least one surface region 184 having top and bottom grooves 185 and 186 respectively formed therein and guide rail holes 187, only one of which is shown in FIG. 2A, for receiving guide rails 200. Optionally, as indicated in the figure, the at least one surface region 184 comprises two symmetrically positioned surface regions 184.

For each surface region 184 of zoom platform 180, housing 202 comprises a resilient latch 206 having a latch tooth 207 formed to match and mate with grooves 185 and 186 in the surface region, which function as catches for the latches. Latches 206 and top grooves 185 cooperate to dock zoom platform 180 in a wide-angle position and the latches 206 and bottom grooves 186 cooperate to dock zoom platform in a telephoto position When latch teeth 207 are seated in top grooves 185 the zoom platform and thereby the zoom lens 111 mounted thereto are secured in a wide-angle position along optic axis 23. When latch teeth 207 are seated in bottom grooves 186, the zoom platform, and thereby zoom lens 111, are secured in a telephoto position along optic axis 23. When zoom platform 180 is docked in either position, AF platform 160 can be moved for focusing relative to platform 180 from a position at which the two platforms touch to a distance at which teeth 171 catch on steps 182. (Range of motion of platform 160 relative to platform 180 was noted above.)

FIG. 2D shows a schematic cutaway view of camera module 120 partially assembled in which latch teeth 207 are seated in top grooves 185 and zoom platform 180 and thereby the zoom lens 111, is secured in a wide-angle position along optic axis 23. FIG. 2E shows a schematic cutaway view of camera module 120 partially assembled, in which latch teeth 207 are seated in bottom grooves 186 and zoom platform 180, and thereby zoom lens 111, is secured in a telephoto position along the optic axis.

Housing 202 optionally comprises two protrusions 203, each formed with a guide rail hole 204 for receiving guide rails 200 and a recess 210 for each piezoelectric motor 60 for mounting the motor to the housing so that the motor may be urged by resilient element 143 towards drive collar 141. In the perspective of FIG. 2B, only one motor recess 210 is shown. Optionally, recess 210 is fitted with a motor mount such as motor mount 80 shown in FIG. 1C. Optionally, recess 210 comprises a holding frame 209 that grasps motor 60 and maintains its position in a direction perpendicular to the plane of the motor. Optionally, recess 210 comprises an arrangement of support nubs and resilient elements similar to support nubs 87 and resilient elements 86 shown in inset 85 of FIG. 1C for supporting motor 60. Optionally, the resilient element, represented by coil spring 143 in FIG. 2A, that presses motor 60 to collar 141 comprises a leaf spring 215 that fits into a top part of recess 210.

Camera module 120 is optionally assembled by inserting zoom platform 180 between coupling arms 170 of AF platform 160 and screwing the platform into drive-tube 140 so that threads 162 on the AF platform mesh with threads 142 in the drive-tube. Drive-tube 140 is inserted into well 131 so that drive collar 141 contacts and rides on wheels 134. Piezoelectric motors 60 and their associated resilient elements 143 that press the motors to drive collar 141 are mounted in recesses 210 in housing 202 and the housing is joined with base 130. Guide rails 200 are inserted into guide rail holes 204 in the housing so that they pass through guide rail holes 187 (FIG. 2A) in zoom platform 180 and guide rail holes 163 in AF platform 160.

AF platform 160 and its AF lens 110 are selectively translated up or down along optic axis 23 and positioned along the optic axis by controlling piezoelectric motors 60 to rotate drive-collar 141 and thereby drive-tube 140 in a suitable clockwise or counterclockwise direction. Because threads 162 of AF platform 160 mesh with threads 142 of the drive-tube and guide rails 200 prevent rotation of the AF platform, rotation of the drive-tube translates AF platform 160 along optic axis 23.

In accordance with an embodiment of the invention, zoom platform 180 is moved between a telephoto and wide-angle position by moving AF platform 160. For example, assume that zoom platform 180 is docked at the telephoto position shown in FIG. 2E with latches 206 engaged in bottom grooves 186 of the zoom platform. To move zoom platform 180 to the wide-angle position, piezoelectric motors 60 are controlled to rotate drive-tube 140 and translate AF platform down until teeth 171 of coupling arms 170 (FIG. 2C) engage steps 182. Thereafter, continued translation of AF platform 160 downwards disengages latch teeth 207 from bottom grooves 186 and pulls zoom platform 180 down until the latch teeth engage top grooves 185 and dock zoom platform 180 and its zoom lens 111 in the wide-angle position shown in FIG. 2D. After docking zoom lens 180 in its wide-angle position, AF platform 160 may be translated upwards along optic axis 23 through a distance schematically indicated by a double arrowhead line 211 without disengaging zoom platform 180 from its wide-angle position. AF platform 160 may be positioned at any point along the distance indicated by double arrowhead line 211 to focus a scene being imaged by camera module 120 in the wide-angle configuration.

To move zoom platform 180 back to its telephoto position, AF platform 160 is moved up until it contacts zoom platform 180 and thereafter pushes the zoom platform up until latches 206 engage bottom grooves 186 and dock the zoom platform in the telephoto position. With zoom platform 180 in the telephoto position, AF platform 160 may be moved downwards by a distance indicated by double arrowhead line 212 without disengaging zoom platform from its telephoto position. AF platform 160 may be positioned at any point along distance indicated by double arrowhead line 212 to focus a scene being imaged by camera module 120 in the telephoto configuration. (At the “bottom” of distance 212 teeth 171 of coupling arms 170 engage step 182 (FIG. 2C) and further motion of the AF platform disengages the zoom platform from the telephoto position and drags the zoom platform towards it wide-angle position.)

In accordance with an embodiment of the invention, camera module 120 is incorporated into a portable communication device such as a cell phone similarly to the manner in which camera module 20 is incorporated into a cell phone and optionally as illustrated in FIG. 1G.

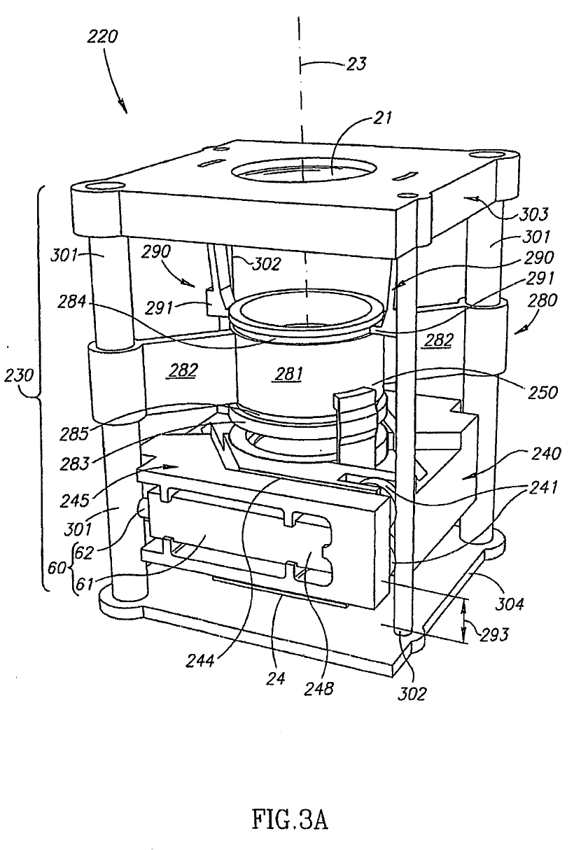

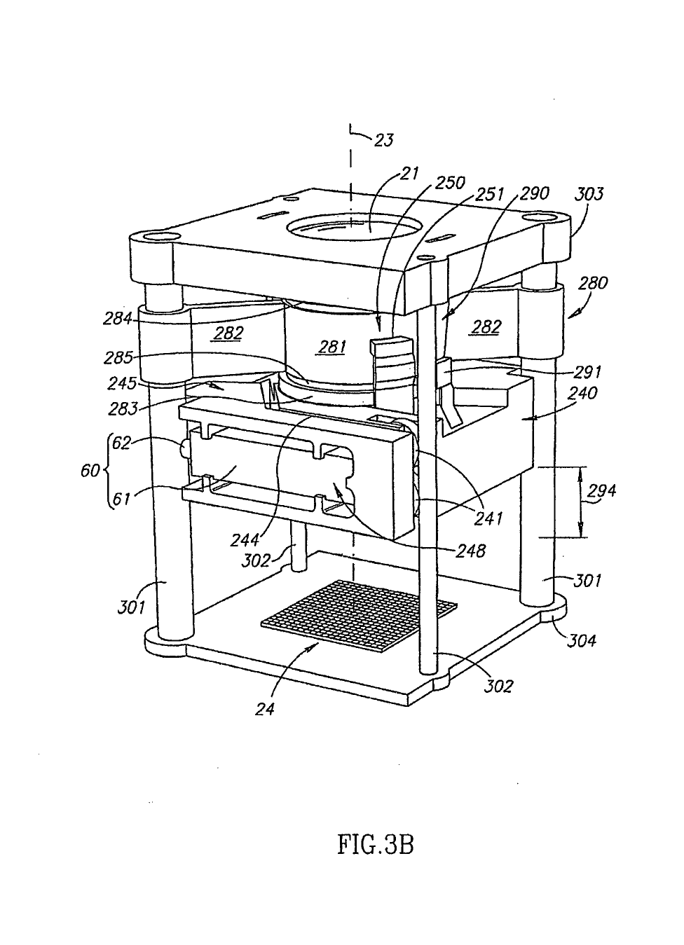

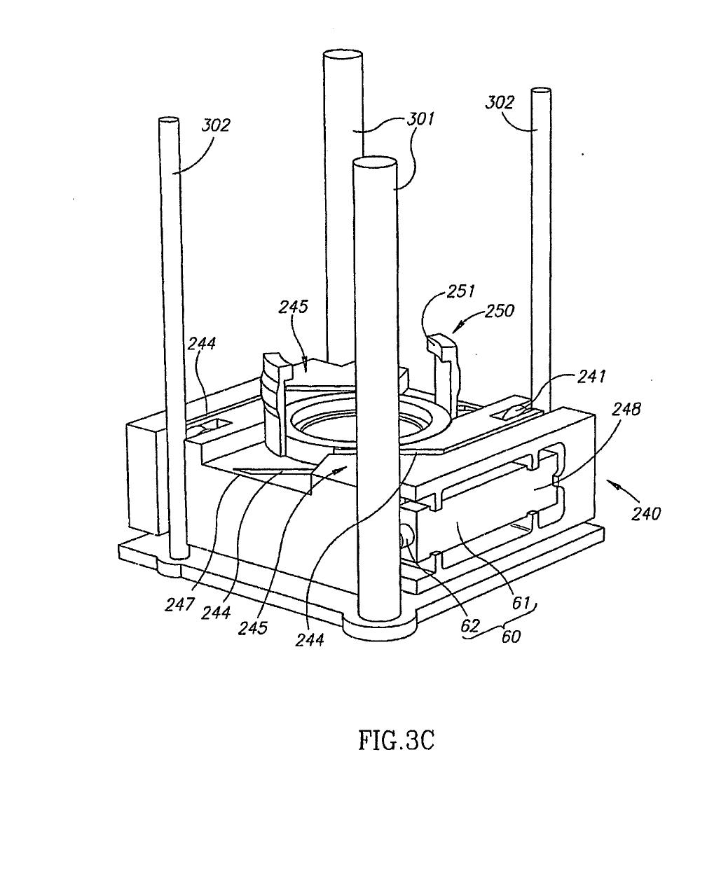

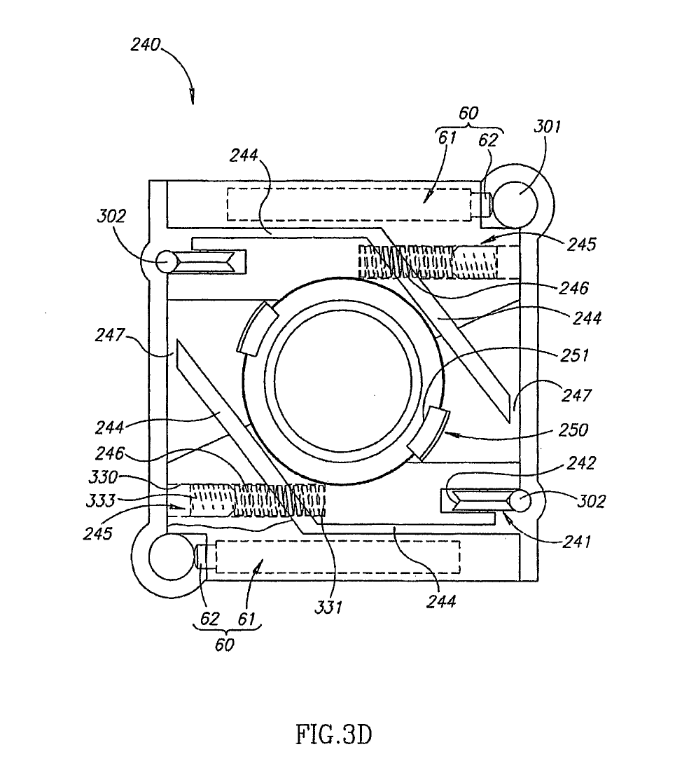

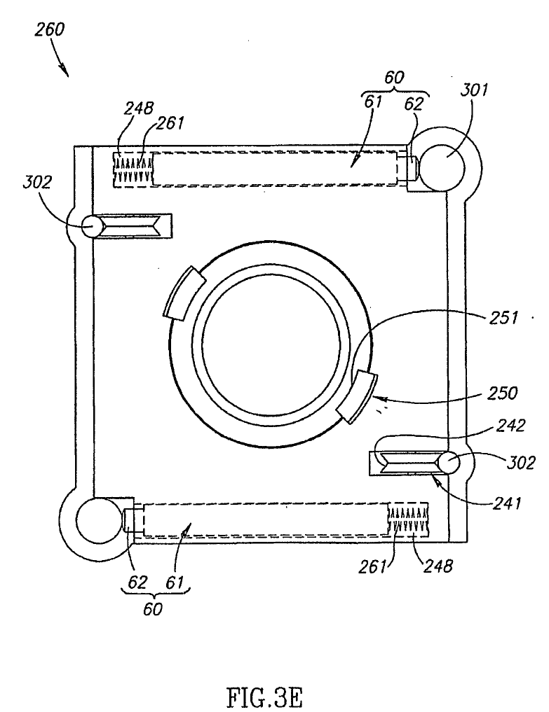

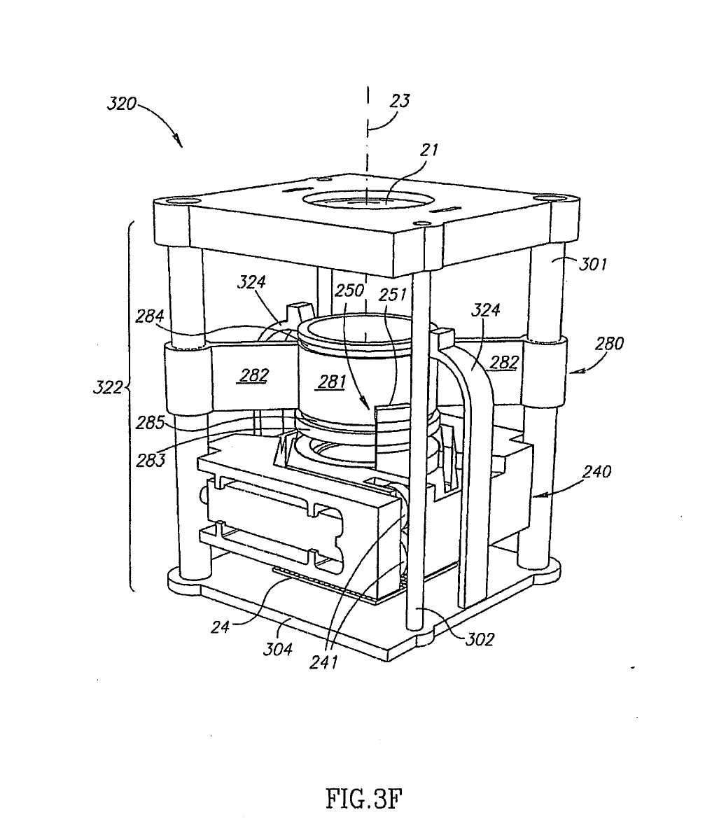

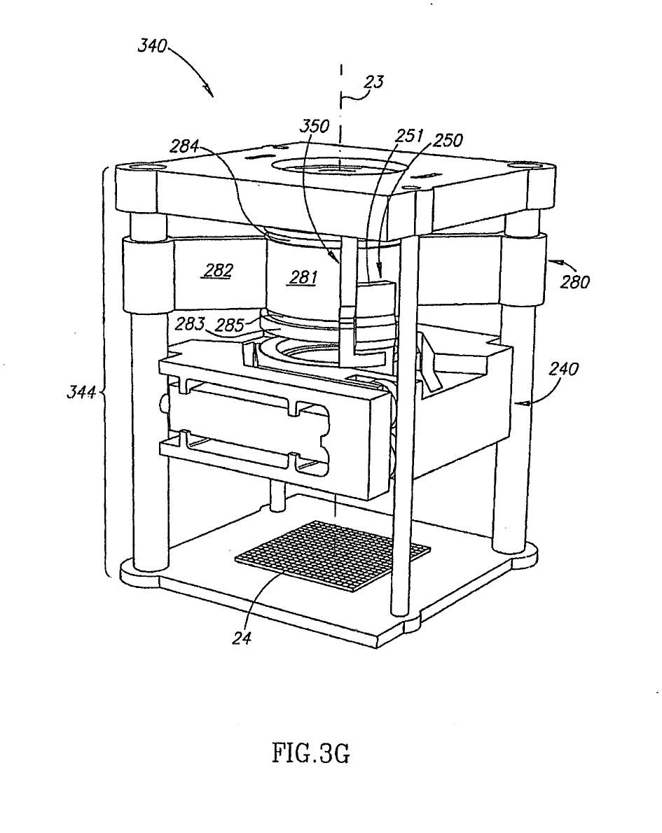

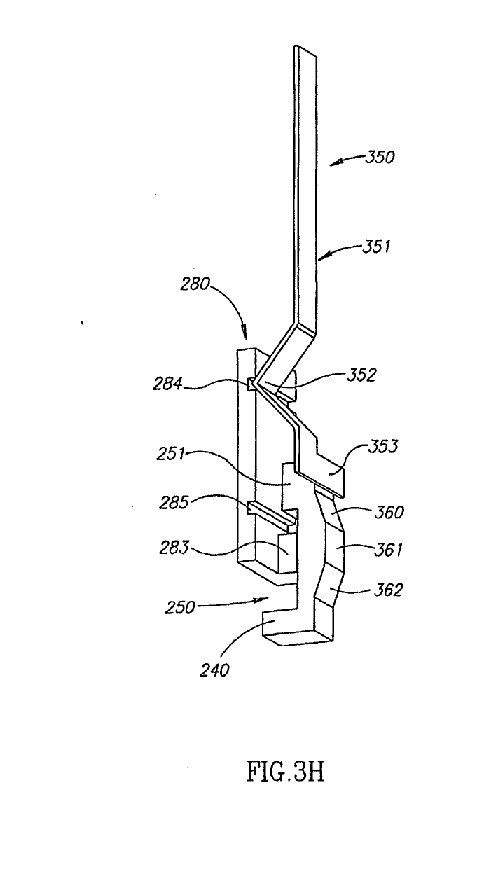

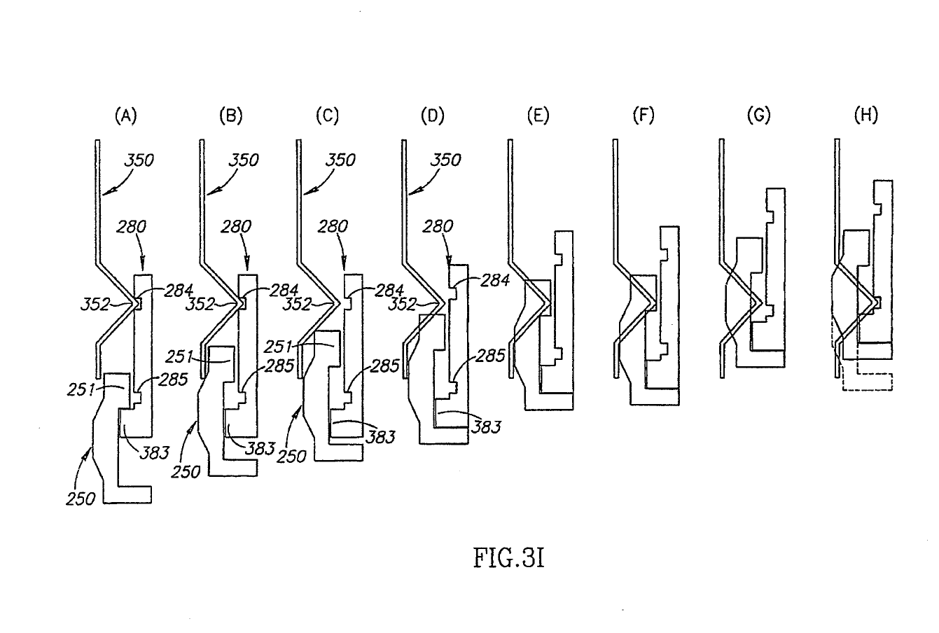

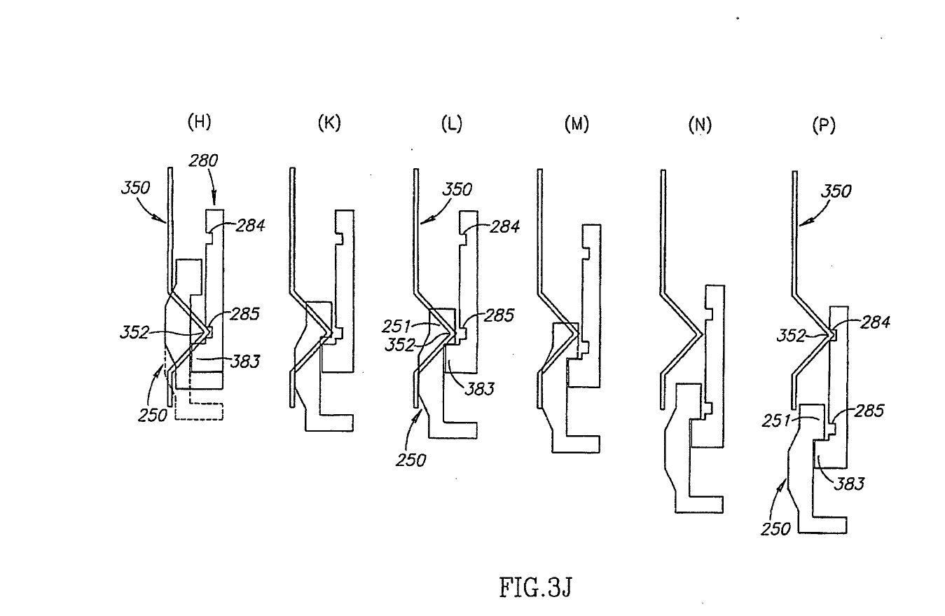

FIGS. 3A and 3B schematically show perspective views of a camera module 220 comprising a shinny-drive 230, in accordance with an embodiment of the invention. Only features of camera module 220 germane to the discussion are shown in the figures.

Shinny-drive 230 comprises an AF platform 240, a zoom platform 280 and optionally two drive rails 301 and two guide rails 302, a top panel 303 and a bottom panel 304. The drive and guide rails are clearly shown in FIG. 3C, which schematically shows a perspective view of parts of shinny-drive 230. A collecting lens 21 having an optic axis coincident with an optic axis 23 of camera module 220 is optionally mounted in top panel 303. A CCD or CMOS photosurface 24 (FIG. 3B) is optionally mounted on bottom panel 304, which functions as or comprises a wiring substrate for the photosurface.

In accordance with an embodiment of the invention, AF platform 240 comprises at least one guide wheel 241 that rides along each guide rail 302. Optionally, as shown in FIGS. 3A and 3B, the at least one guide wheel comprises two guide wheels 241. Details of AF platform 240 are shown in FIG. 3C referred to above and in FIG. 3D, which schematically shows a plan view of AF platform 240. Optionally, AF platform 240 is formed with two slots 244, each of which defines an arm 245 that is attached to a main central body of the platform by a relatively thin neck 247 (arms 245 and necks 247 are clearly shown in FIGS. 3C and 3D). A piezoelectric motor 60 is mounted in a recess 248 in each arm 245.

A slot 244 and the relatively thin neck 247 associated with an arm 245 enables the arm to elastically bend about an axis substantially perpendicular to the plane of AF platform 240 that is located in the region of neck 247. In accordance with an embodiment of the invention, a resilient element, optionally a coil spring 246 (FIG. 3D) is inserted into each slot 244 and resiliently biases and tends to bend the arm 245 associated with the slot 244 away from the main body of AF platform 240. As a result, arms 245 generate a resilient torque that urges each piezoelectric motor 60 towards its associated drive rail 301 so that the motor's friction nub 62 resiliently contacts the drive rail and guide wheels 241 resiliently press guide rails 302. Guide wheels 241 and guide rails 302 are formed so as to minimize lateral motion of the guide wheels relative to the rails and maintain the position of AF platform 240 accurately registered to the drive and guide rails. Optionally, this is accomplished by forming each guide wheel 241 with an optionally “V” groove 242 (FIG. 3D) into which its associated guide rail fits.

In some embodiments of the invention, to receive resilient element 246 associated with a given arm 245, the arm is formed with a threaded through hole 330 schematically indicated in FIG. 3D with dashed lines and the main body of the platform is formed with a blind hole 331 indicated with dashed lines. Resilient element 246 is inserted through threaded hole 330 until it seats in blind hole 331. A setscrew 333 having threads matching those of threaded hole 330 is screwed Into the hole to lock resilient element 246 in place. The depth to which setscrew 333 is screwed into threaded hole 330 is adjusted to provide a desired compression of resilient element 246 and thereby a desired force that presses piezoelectric motor 60 associated with arm 245 to its associated drive rail 301.

In some embodiments of the invention, each arm 245 is formed separately from the main body of platform 240. Optionally, arm 245 is formed not with a hole 330 through which resilient element 246 may be inserted to seat in blind hole 331 in the main body of platform 240 but with a hole, optionally a blind hole, in which the resilient element may be seated. The main body of platform 240 is optionally permanently attached to arm 245 after resilient element 246 is positioned between the main body and the arm in the holes provided for the resilient element. Optionally the arm and the main body are subsequently welded to permanently attach them.

In some embodiments of the invention, material from which platform 240 is formed and the structure of neck 247 is configured so that arm 245 can be bent to open slot 244 sufficiently so that resilient element 246 may be inserted between the arm and the main body of the platform.

In some embodiments of the invention, a resilient element is positioned inside recess 248 that receives piezoelectric motor 60 along an edge of the motor opposite friction nub 62 to press the friction nub to drive rail 301 associated with the arm. Optionally, for embodiments in which resilient elements are positioned inside recesses 248 AF platform 240 is formed without slots 244 and does not comprise arms 245. Resilient bending of arms 245 is not used to press friction nubs 62 of motors 60 to their respective drive rails. FIG. 3E schematically shows a top view of an AF platform 260 similar to AF platform 240 but formed without slots 244 and arms 245. Each piezoelectric motor 60 mounted in the platform is pressed to its respective drive rail 301 by a resilient element 261 positioned in recess 248 in which the motor is mounted.

AF platform 240 is controlled to move selectively up or down drive and guide rails 301 and 302, and thereby to move and position its AF lens (not shown) along optic axis 23 of camera module 220 by electrifying electrodes in piezoelectric motors 60 to excite appropriate, optionally elliptical, vibrations in friction nubs 62. (As noted above, “up” and “down” refer to directions towards or away from collecting lens 21 in FIGS. 3A and 3B.) The vibrations cause the motors and thereby the platform to respectively “shinny” up or down the rails. Optionally, a drive rail 301 is made from a wear resistant material and/or a region along the drive rail that is contacted by friction nub 62 is covered with a protective wear resistant material.

Whereas, in an embodiment of the invention, AF platform 240 comprises its own piezoelectric motors 60 for moving and positioning the AF platform along optic axis 23, in some embodiments of the invention, as schematically shown in FIGS. 3A and 3B, zoom platform 280 optionally does not comprise its own piezoelectric motors for moving the platform. Instead, similarly to the case of camera module 120 and its turret-drive system 122 (FIGS. 2A-2E), zoom platform 280 in shinny-drive system 230 is moved by motion of AF platform 240, which is formed with optionally two coupling arms 250 for coupling the zoom platform to the AP platform. Coupling arms 250, details of which are clearly shown in FIG. 3C, perform functions similar to those performed by coupling arms 170 in turret-drive system 122 and each is formed with a tooth 251. Operation of the coupling arms and motion of zoom platform 280 is discussed below.

Zoom platform 280 optionally comprises a cylindrical section 281 to which its zoom lens (not shown) is mounted and at least two arms 282 that couple the lens mount optionally to drive rails 301 so that the zoom platform can move freely up and down along the drive rails. Cylindrical section 281 is formed with a bottom lip 283 and top and bottom grooves 284 and 285. Top and bottom grooves 284 and 285 function as catches for elastic latches 290 shown in FIGS. 3A and 3B that optionally extend downward from top panel 303. Elastic latches 290 comprises latch teeth 291 and grooves 284 and 285 are shaped to match the latch teeth.

Latches 290 and top groove 284 cooperate to dock zoom platform 280 in a wide-angle position and the latches and bottom grooves 285 cooperate to dock zoom platform in a telephoto position. When latch teeth 291 are seated in top grooves 284, as shown in FIG. 3A, zoom platform 280 and thereby the zoom lens mounted thereto are secured in the wide-angle position along optic axis 23, relatively far from collecting lens 21. When latch teeth 291 are seated in bottom groove 285, as shown in FIG. 3B, the zoom platform and thereby the zoom lens mounted thereto are secured in the telephoto position along optic axis 23.

To move zoom platform 280 from its telephoto position (FIG. 3B) to its wide-angle position (FIG. 3A) piezoelectric motors 60 are controlled to shinny AF platform down until teeth 251 of coupling arms 250 catch on bottom lip 283 of the zoom platform. Thereafter, continued translation of AF platform 240 downward disengages latch teeth 291 from bottom groove 285 and pulls zoom platform 280 down until the latches engage top groove 284 and dock the zoom platform and its zoom lens in the wide-angle position shown in FIG. 3A. After docking zoom platform 280 is in its wide-angle position, AF platform 240 may be translated upwards along optic axis 23 through a distance indicated by a double arrowhead line 293 without disengaging zoom platform 280 from its wide-angle position. AF platform 240 may be positioned at any point along the distance indicated by double arrowhead line 293 to focus a scene being imaged by camera module 120 in the wide-angle configuration.

To move zoom platform 280 back to the telephoto position (FIG. 3B), AF platform 240 is moved up until it contacts zoom platform 280 and thereafter pushes the zoom platform up until latches 290 engage bottom grooves 285 and dock the zoom platform in the telephoto position. With zoom platform 280 in the telephoto position, AF platform 240 may be moved downwards by a distance indicated by a double arrowhead line 294 without disengaging zoom platform from its telephoto position. AF platform 240 may be positioned at any point along distance 294 to focus a scene being imaged by camera module 120 in the telephoto configuration.

Latches 290 do not of course have to be mounted to and extend downward from top panel 303. Other configurations of latches suitable for the performance of the invention may be used and can be advantageous. For example, FIG. 3F schematically shows a camera module 320, in accordance with an embodiment of the invention comprising a shinny-drive 322 similar to shinny-drive 230 (FIG. 3A) in which docking latches 324 are mounted to and extend upward from bottom panel 304.

FIG. 3G schematically shows another configuration of latches 350 comprised in a shinny-drive system 344 of a camera module 340, in accordance with an embodiment of the invention. Whereas, in turret-drive and shinny-drive systems 122 and 230, latches do not contact coupling arms 170 and 250 during operation of the systems, latches 350 contact coupling arms 250 during operation of shinny-drive system 344. The latches are shaped so that the coupling arms contact and apply forces to the latches to disengage the latches from the groove 284 or 285 in which they are seated.

FIG. 3H schematically shows details of the configuration of latch 350 shown in FIG. 3G and its corresponding coupling arm 250 in relation to bottom lip 283 and top and bottom grooves 284 and 285 of zoom platform 280, in accordance with an embodiment of the invention. A portion of AF platform 240 shown in FIG. 3G to which coupling arm 250 is attached is shown in FIG. 3H and identified in the figure by the numeral 240.

Latch 350 is optionally fabricated from a resilient spring-like material and comprises an arm 351 formed having a region 352, hereinafter referred to as a “catch” adapted to snap into and catch in grooves 284 and 285 and a release handle 353 that extends to a side of arm 351. Coupling arm 250 has, as noted before, a tooth 251, and has first and second sloped panels or surfaces 360 and 362 respectively on either side of a vertical (i.e. parallel to optic axis 23 of camera module 120 shown in FIG. 3G) panel 361. Sloped and vertical panels 360. 362 engage release handle 353 during motion of AF platform 240 to move zoom platform 280 from one to the other of its wide-angle and telephoto positions and apply forces to the handle that lift it and thereby disengage catch 352 of latch 350 from groove 284 or 285 respectively in which it is seated.

Operation of coupling arm 250 and latch 350 during motion of zoom platform 280 from its wide angle position, in which catch 352 is engaged in top groove 284, to its telephoto position, in which catch 352 is engaged in bottom groove 285, is illustrated in a time sequence of images shown in FIG. 3I. The images in the figure show the relative position of the latch and coupling ann during motion of the zoom platform. In the figure, time increases from left to right and each image in the sequence is labeled with a letter of the alphabet. Images labeled with a letter farther along in the alphabet sequence are farther to the right and are later in time than figures farther to the left. Operation of coupling arm 250 and latch 350 during moving of zoom platform 280 from its telephoto position to its wide-angle position is illustrated in a time sequence of images shown in FIG. 3J.

Whereas camera modules in FIGS. 3A, 3B, 3F and 3G comprise an AF platform having piezoelectric motors and a zoom platform that does not have piezoelectric motors and is moved by the AF platform, in some embodiments of the invention, both an AF and a zoom platform are independently moved and positioned by their own piezoelectric motors.

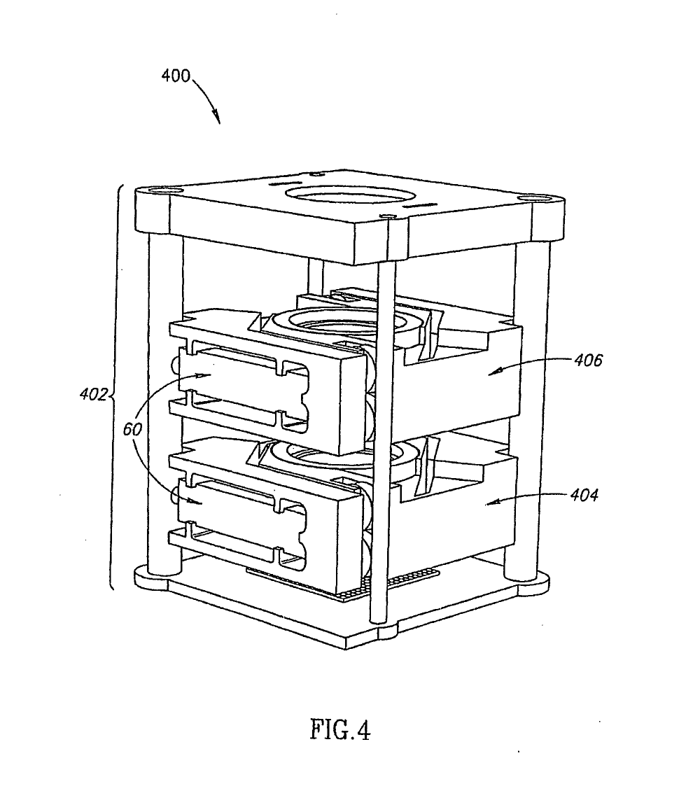

FIG. 4 schematically shows a camera module 400 comprising a shinny-drive system 402 having an AF platform 404 and a zoom platform 406 each of which platforms is mounted with its own piezoelectric motors 60, in accordance with an embodiment of the invention. Optionally, the platforms are similar. Optionally, with the possible exception of the lens configurations with which they are mounted and components that mount their respective lenses to the platforms, the platforms are identical.

Independent control of the motion and positioning of AF and zoom platforms 404 and 406 enables their respective AF and zoom lenses to be positioned and moved independently of each other. As a result, camera module 400 is in general, more flexible than a camera module in which the zoom platform is constrained to be moved by the AF platform and assume a limited number of fixed positions along the camera modules optic axis. A camera module similar to camera module 400, in accordance with an embodiment of the invention, that provides independent control of its AF and zoom platforms can generally be configured to provide a greater continuous range of magnifications than that provided by a camera module that does not provide independent control.

It is noted, that whereas camera modules in accordance with embodiments of the invention have been described as being configured sufficiently small to be incorporated into a cell phone, camera modules in accordance with embodiments of the invention may be made in different sizes and are not limited to being used in a cell phone or portable terminals. For example, a camera module similar to an exemplar embodiment of a camera module described above may be made in “conventional sizes” and used in or as a “conventional camera”. Relatively small camera modules in accordance with an embodiment of the invention, such as are suitable for incorporation into small cell phones, may be incorporated for example in bar code readers or personal accessories and/or wearables such as key chains and glasses.

In the description and claims of the present application, each of the verbs, “comprise” “include” and “have”, and conjugates thereof, are used to indicate that the object or objects of the verb are not necessarily a complete listing of members, components, elements or pans of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1-15. (canceled)

16. A camera module having an optic axis and comprising:
a drive-tube rotatable about the optic axis and having an inside surface formed with a thread and an axis of rotation coincident with the optic axis;
a first platform mounted inside the drive-tube having a thread that meshes with the thread of the drive-tube and comprising at least one lens that receives and transmits light from a scene being imaged by the module;
a second platform mounted inside the drive tube which does not have threads that mesh with the threads of the drive-tube and comprises at least one lens that receives and transmits light from the scene;
at least one guide rail along which the first and second platforms slides freely that prevents the platforms from rotating when the drive tube is rotated; and
at least one piezoelectric motor controllable to rotate the drive tube and thereby to move and position the first platform along the optic axis.

17. A camera module according to claim 16 wherein the piezoelectric motor comprises a coupling surface that is pressed to a contact surface of the tube and is controlled to generate motion in its coupling surface to rotate the tube.

18-27. (canceled)

28. A camera module according to claim 16 wherein the second platform is coupled to the first platform so that it can slide along the optic axis between first and second positions relative to the first platform.

29. A camera module according to claim 28 wherein at the first position, the first and second platforms substantially touch.

30. A camera module according to claim 16 and comprising at least one latch and a matching catch operable to secure the second platform at at least one predetermined position along the optic axis.

31. A camera module according to claim 30 wherein the catch comprises a groove formed in the second platform.

32. A camera module according to claim 31 wherein the latch extends along a direction parallel to the optic axis.

33. A camera module having an optic axis and comprising:
at least one drive rail parallel to the optic axis;
at least one first platform comprising at least one lens that receives and transmits light that reaches the camera module from a scene being imaged by the module and comprises at least one piezoelectric motor having a coupling surface for transmitting kinetic energy from the motor to a moveable body;
at least one guide rail parallel to the drive rail along which the platform moves substantially freely that prevents the platform from rotating relative to the drive rail,
a resilient body that operates to urge the coupling surface to the drive rail and generate force between the coupling surface and drive rail, which force produces a torque that urges the platform to the at least one guide rail;
wherein, the at least one piezoelectric motor is controllable to excite vibrations in the coupling surface that apply force to the drive rail so as to move and position the first platform along the optic axis.

34. A camera module according to claim 33 wherein the at least one drive rail comprises a plurality of parallel drive rails.

35. (canceled)

36. A camera module according to claim 33 wherein the platform comprises a main central body and for each piezoelectric motor of the at least one piezoelectric motor an arm connected to the main central body that holds the motor.

37. A camera module according to claim 36 wherein the arm is connected to the main body of the platform by a relatively thin neck that enables the arm to elastically bend away from the main body.

38. A camera module according to claim 36 wherein the arm is an integral part of the platform defined by a slot formed in the platform.

39. (canceled)

40. A camera module according to claim 36 wherein the resilient body operates to urge the arm away from the main body of the platform.

41-48. (canceled)

49. A camera module according to claim 33 wherein the at least one guide rail comprises a plurality of parallel guide rails.

50. (canceled)

51. A camera module according to claim 33 comprising a second platform having at least one lens that receives and transmits light that reaches the camera module from the scene.

52. A camera module according to claim 51 wherein the second platform is coupled to a first platform of the at least one first platform so that it can slide along the optic axis between first and second positions relative to the first platform.

53. A camera module according to claim 52 wherein at the first position the first and second platforms substantially touch.

54. A camera module according to claim 51 and comprising at least one latch and a matching catch operable to secure the second platform at at least one predetermined position along the optic axis.

55. A camera module according to claim 54 wherein the catch comprises a groove formed in the second platform.

56. A camera module according to claim 54 wherein the latch extends along a direction parallel to the optic axis.

57-58. (canceled)

59. A portable terminal comprising a camera module according to claim 16.

60. A portable terminal according to claim 59 and comprising a communication module for transmitting and/or receiving signals.

61-65. (canceled)

66. A portable terminal according to claim 59 wherein the portable terminal comprises a cell phone.

67. A portable terminal according to claim 59 wherein the portable terminal comprises a bar-code reader.

68. A portable terminal comprising a camera module according to claim 33.

69. A portable terminal according to claim 68 and comprising a communication module for transmitting and/or receiving signals.

70. A portable terminal according to claim 68 wherein the portable terminal comprises a cell phone.

71. A portable terminal according to claim 68 wherein the portable terminal comprises a bar-code reader.
